(19) United States
(12) Patent Application Publication
(10) Pub. No.: US 2024/0414561 A1
(43) Pub. Date: Dec. 12, 2024

(54) SELF-CONFIGURATION OF MULTI-PROTOCOL NODES IN HETEROGENEOUS NETWORK

(71) Applicant: Silicon Laboratories Inc., Austin, TX (US)

(72) Inventor: Hasan Ali Stationwala, Hyderabad (IN)

(21) Appl. No.: 18/206,178

(22) Filed: Jun. 6, 2023

(51) Int. Cl. H04W 24/02; H04W 76/18

(52) U.S. Cl. CPC H04W 24/02; H04W 76/18

(57) ABSTRACT

A technique for configuring multi-protocol nodes for IoT applications initially configures the multi-protocol nodes in a PAN network (e.g., a BLE mesh network). In response to a trigger, the multi-protocol nodes self-configure into a heterogeneous network accessible by a smart device. Each multi-protocol node enables LAN communications and searches for a LAN networking device for a predetermined interval. Nodes directly reachable by a LAN networking device reconfigure themselves to serve as a proxy to nodes that are out of range of the LAN networking device. The multi-protocol nodes publish their LAN connectivity status to neighboring nodes. After each of the multi-protocol nodes have received the connectivity status of corresponding neighboring nodes, the nodes determine their role in a heterogeneous network, e.g., a pure Wi-Fi node, a Wi-Fi-to-BLE mesh bridge connectivity node, or a pure BLE mesh node, and self-configure in a corresponding connectivity mode.

### BACKGROUND

### Field of the Invention

This disclosure relates to communications systems in general, and more particularly to networks of radio frequency (RF) communications systems.

### Description of the Related Art

In a conventional Internet of Things (IoT) ecosystem (e.g., a lighting system), hundreds of nodes (e.g., light bulbs) need to be accessible on demand via the Internet. The nodes may be preinstalled during construction without knowledge of a potential location for a networking device of a local area network (i.e., LAN, e.g., an access point of a wireless local area network compliant with an IEEE 802.11 protocol) that is typically installed after construction. However, it is desirable to have all nodes of the IoT ecosystem simultaneously accessible using a single wireless communications device even in the absence of LAN connectivity. A personal area network (i.e., PAN, e.g., a Bluetooth® Low Energy (BLE) network) designed for low power and low latency applications may be used to access the nodes before a LAN becomes available. However, when a LAN does become available, some of the nodes may be out of the range of a networking device (e.g., an access point) of the LAN. For example, when Wi-Fi access points are installed inside a house and IoT nodes are installed outside the house in a garage or yard, some of the IoT nodes may be out of the range of the access point. Accordingly, improved techniques for configuring IoT nodes are desired.

### SUMMARY OF EMBODIMENTS OF THE INVENTION

In at least one embodiment, a method for operating a network of multi-protocol nodes includes searching for a networking device associated with a first communications protocol by a first multi-protocol node of a plurality of multi-protocol nodes. The method includes the first multi-protocol node configuring itself to enable a first connectivity mode using the first communications protocol, enable a second connectivity mode using a second communications protocol, or enable a bridge connectivity mode using the first communications protocol and the second communications protocol based on whether the first multi-protocol node detects the networking device.

In at least one embodiment, a network of multi-protocol nodes includes a multi-protocol node. The multi-protocol node includes a radio frequency transceiver configured to transmit and receive radio frequency signals. The multi-protocol node includes data processing circuitry operable to: use the radio frequency transceiver to search for a networking device associated with a first communications protocol. The data processing circuitry is operable to enable only a first connectivity mode using the first communications protocol, enable only a second connectivity mode using a second communications protocol, or enable a bridge connectivity mode using the first communications protocol and the second communications protocol based on whether the multi-protocol node detects a networking device.

In at least one embodiment, a multi-protocol node includes a storage element and a processor configured to execute instructions stored in the storage element. The instructions are executable to selectively update a corresponding connectivity mode from an initial connectivity mode based whether the multi-protocol node detects a networking device and based on another corresponding connectivity mode of a neighboring multi-protocol node.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a plurality of multi-protocol nodes communicatively coupled using a personal area network communications protocol.

FIG. 2 illustrates a functional block diagram of an exemplary wireless communications receiver of FIG. 1.

FIG. 3 illustrates a functional block diagram of an exemplary wireless communications transmitter of FIG. 1.

FIG. 4 illustrates a functional block diagram of the communications protocol stacks executing on an exemplary multi-protocol wireless communications device of FIG. 1.

FIG. 5 illustrates a network of multi-protocol nodes communicatively coupled to a smart device using a personal area network communications protocol.

FIG. 6 illustrates a network of multi-protocol nodes communicatively coupled to a smart device using a wireless local area network protocol and a personal area network protocol.

FIG. 7 illustrates an exemplary information and control flow for self-configuration of multi-protocol nodes in a heterogeneous network consistent with at least one embodiment of the invention.

FIG. 8 illustrates a functional block diagram of a heterogeneous network of self-configuring multi-protocol nodes consistent with at least one embodiment of the invention.

FIG. 9 illustrates a functional block diagram of a reconfigured heterogeneous network of self-configuring multi-protocol nodes consistent with at least one embodiment of the invention.

The use of the same reference symbols in different drawings indicates similar or identical items.

### DETAILED DESCRIPTION

A technique for configuring multi-protocol wireless communications devices (i.e., multi-protocol devices or multi-protocol nodes) for IoT applications initially configures the multi-protocol nodes in a PAN (e.g., a Bluetooth Low Energy (BLE) mesh network). In response to a trigger, the multi-protocol nodes self-configure into a heterogeneous network accessible by a smart device. Each multi-protocol node enables LAN (e.g., Wi-Fi®) communications and searches for a LAN networking device for a predetermined interval. Multi-protocol nodes directly reachable by a LAN (e.g., an access point) reconfigure themselves to serve as a proxy to multi-protocol nodes that are out of range of the LAN networking device. The multi-protocol nodes publish their LAN connectivity status (e.g., connected to Wi-Fi connected or not connected to Wi-Fi) to neighboring multi-protocol nodes. A first node is considered to be a neighbor to a second node if the first node can directly listen to wireless transmissions from the second node without a relay. If two Wi-Fi nodes can listen to a common BLE node, then both Wi-Fi nodes are neighbors of the BLE node and act as a Wi-Fi-to-BLE mesh bridge connectivity node. After each of the multi-protocol nodes have received the connectivity status of corresponding neighboring nodes, the multi-protocol nodes determine their role in a heterogeneous network, e.g., a pure Wi-Fi node, a Wi-Fi-to-BLE mesh bridge connectivity node, or a pure BLE mesh node, and self-configure in a corresponding connectivity mode. For example, a pure Wi-Fi node has only neighboring multi-protocol nodes that are connected to the LAN networking device and has Wi-Fi communications enabled but may have BLE mesh communications disabled. A Wi-Fi-to-LE mesh bridge connectivity node has at least one neighboring multi-protocol node that is not connected to Wi-Fi and has Wi-Fi and BLE mesh communications enabled. A pure BLE mesh node is out of range of a Wi-Fi access point and has BLE mesh communications enabled but may have Wi-Fi communications disabled.

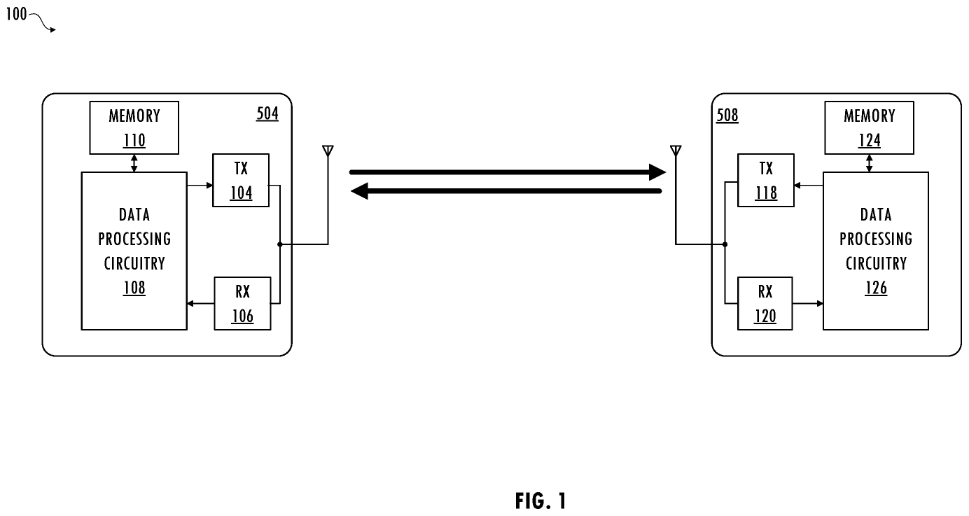

Referring to FIG. 1, in at least one embodiment, IoT ecosystem 100 includes multi-protocol node 504, having transmitter 104, receiver 106, data processing circuitry 108, and memory 110, and multi-protocol node 508, which includes transmitter 118, receiver 120, data processing circuitry 126, and memory 124. Although multi-protocol node 504 and multi-protocol node 508 are illustrated as each including only one transmitter, receiver, and antenna, in other embodiments of IoT ecosystem 100, multi-protocol node 504 or multi-protocol node 508 include multiple transmitters, receivers, and antennas. IoT ecosystem 100 can communicate data modulated using multiple wireless communications protocols, e.g., data modulated using a PAN protocol (e.g., BLE based protocols) and data modulated using a LAN protocol (e.g., a Wi-Fi protocol). However, in other embodiments, IoT ecosystem 100 is capable of transmitting and receiving data compliant with other wireless communications protocols.

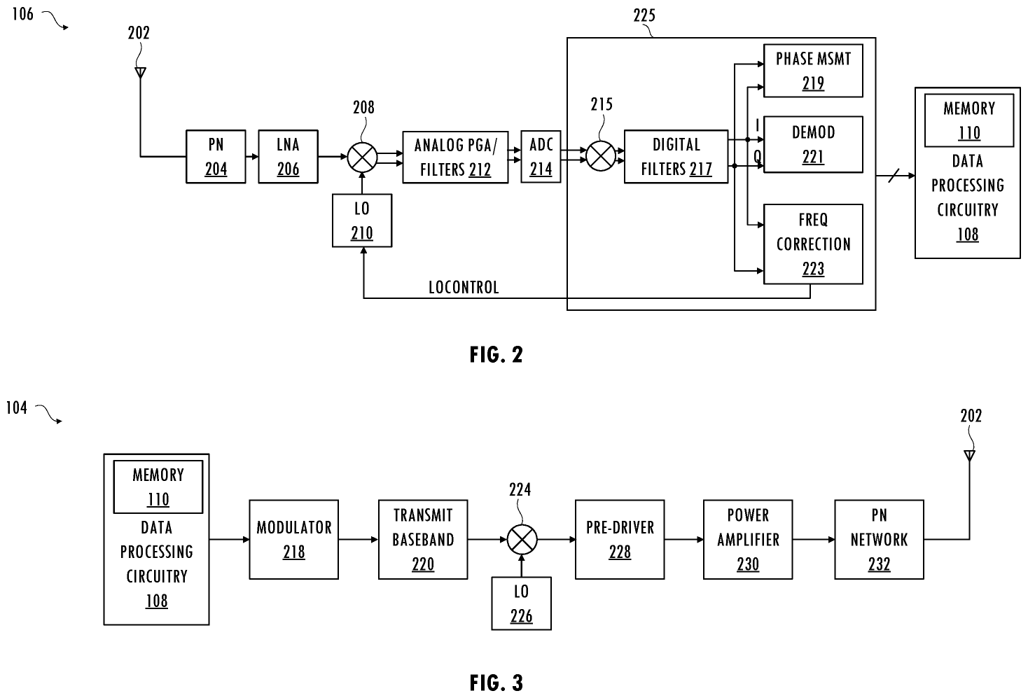

FIG. 2 illustrates an exemplary embodiment of receiver 106 that may be included in physical radio of the multi-protocol nodes described above. Antenna 202 provides an RF signal to passive network 204, which provides impedance matching, filtering, and electrostatic discharge protection. Passive network 204 is coupled to low-noise amplifier (LNA) 206, which amplifies the RF signal without substantial degradation to the signal-to-noise ratio and provides the amplified RF signal to frequency mixer 208. Frequency mixer 208 performs frequency translation or shifting of the RF signal using a reference or local oscillator (LO) signal provided by local oscillator 210. For example, in at least one operational mode of receiver 106, frequency mixer 208 translates the RF signal from a 2.4 GHz frequency band to baseband frequencies centered at DC (i.e., zero-intermediate frequency (ZIF) in a ZIF mode of operation). In another operational mode, receiver 106 is configured as a low-intermediate frequency (LIF) receiver (i.e., in a LIF mode of operation) and frequency mixer 208 translates the RF signal to a low-intermediate frequency (e.g., 100-200 kHz) to avoid DC offset and 1/f noise problems of ZIF receivers.

Frequency mixer 208 provides the translated output signal as a set of two signals, an in-phase (I) signal, and a quadrature (Q) signal. The I and Q signals are analog time-domain signals. In at least one embodiment of receiver 106, the analog amplifiers and filters 212 provide amplified and filtered versions of the I and Q signals to analog-to-digital converter (ADC) 214, which converts those versions of the I and Q signals to digital I and Q signals (i.e., I and Q samples). Exemplary embodiments of ADC 214 use a variety of signal conversion techniques (e.g., delta-sigma (i.e., sigma-delta) analog to digital conversion). ADC 214 provides the digital I and Q signals to signal processing circuitry 225. In general, signal processing circuitry 225 performs processing (e.g., demodulation, frequency translation (e.g., using mixer 215), filtering (e.g., digital filters 217), or signal correction) of the digital I and Q signals. In at least one embodiment, signal processing circuitry 225 includes demodulator 221, which retrieves or extracts information from digital I and Q signals (e.g., data signals, that were modulated by a transmitter (not shown) and provided to antenna 202 as RF signals). In at least one embodiment, one or more circuits of data processing circuitry 108 converts digital I and Q signals from a Cartesian representation into polar representation (i.e., instantaneous phase and instantaneous amplitude) for use by frequency correction circuit 223 or phase measurement circuit 219.

Data processing circuitry 108 may perform a variety of functions (e.g., logic, arithmetic, etc.). For example, data processing circuitry 108 may use the demodulated data in a program, routine, or algorithm (whether in software, firmware, hardware, or a combination thereof) to perform desired control or data processing tasks. In at least one embodiment, data processing circuitry 108, which includes memory 110, controls other circuitry, sub-system, or systems of the multi-protocol node (not shown). In an embodiment, data processing circuitry 108 implements a data link layer that includes a state machine, defines state transitions, defines packet formats, performs scheduling, performs radio control, and provides link-layer decryption consistent with at least one wireless communications protocol.

FIG. 3 illustrates an exemplary embodiment of transmitter 104 that may be included in a physical radio of multi-protocol node 504 or multi-protocol node 508 of FIG. 1. Data processing circuitry 108 of FIG. 3 may perform a variety of functions (e.g., logic, arithmetic, etc.). For example, data processing circuitry 108 executes a program, routine, or algorithm (whether in software, firmware, hardware, or a combination thereof) that performs desired control or data processing tasks consistent with a physical layer of a communications protocol and provides data to modulator 218. Modulator 218 provides the modulated data to transmit baseband circuit 220, which in an embodiment includes a digital-to-analog converter and analog programmable gain filters. Transmit baseband circuit 220 provides the baseband (or intermediate frequency (IF)) signal to frequency mixer 224, which performs frequency translation or shifting of the baseband signal using a reference or local oscillator (LO) signal provided by local oscillator 226. In at least one operational mode of transmitter 104, frequency mixer 224 translates the baseband signal centered at DC to a 2.4 GHz frequency band. Pre-driver 228 amplifies the signal generated by frequency mixer 224 to a level sufficient for power amplifier 230. Power amplifier 230 further amplifies the signal to provide a higher power signal sufficient to drive passive network 232 and antenna 202. Passive network 232 provides impedance matching, filtering, and electrostatic discharge protection.

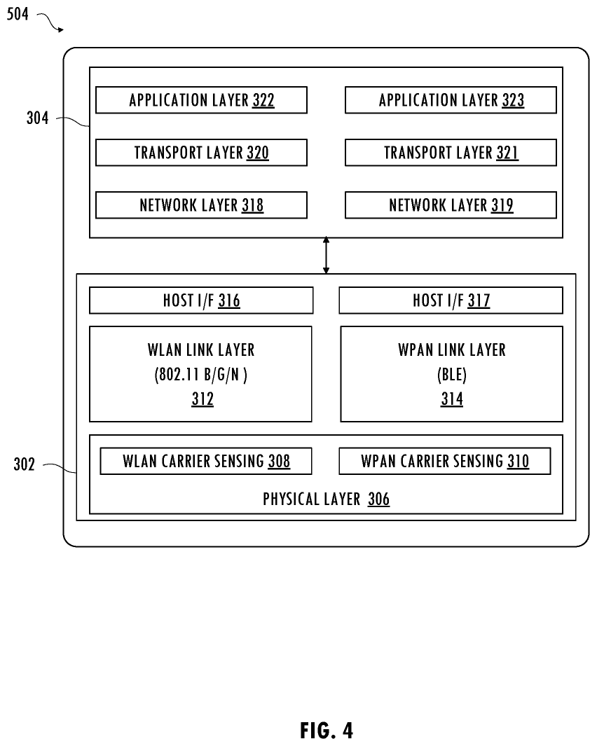

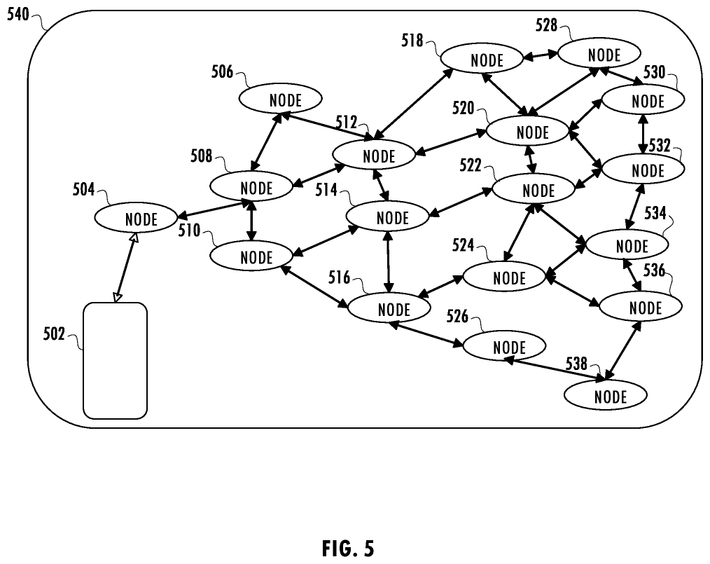

Referring to FIGS. 1 and 4, in an embodiment, data processing circuit 108 includes separate integrated circuits for controller 302 and host 304. In some embodiments, multi-protocol node 504 incorporates functionality of controller 302 and host 304 in a single integrated circuit device. Controller 302 executes instructions to implement portions of the PAN and LAN protocol stacks. For example, controller 302 implements physical layer 306 which includes software that interacts with the RF transceiver (e.g., the transmitter and receiver described above). LAN carrier sensing layer 308 implements coexistence strategies that manage the LAN protocol to operate simultaneously with the PAN protocol using at least some of the same radio frequency resources. PAN carrier sensing layer 310 implements coexistence strategies that manage the PAN protocol to operate simultaneously with the LAN protocol using at least some of the same radio frequency resources. PAN link layer 314 and LAN link layer 312 interface directly to physical layer 306 to handle transmission and reception of associated signals. In at least one embodiment, PAN link layer 314 and LAN link layer 312 of controller 302 communicate with host 304 via host interface 316 and host interface 317, respectively. Host 304 implements upper layers of the communications protocol stacks (e.g., network layer 318, network layer 319, transport layer 320, transport layer 321, application layer 322, and application layer 323, which implement the upper layers for the PAN and LAN protocol stacks). In other embodiments, the layers of the software protocol stacks have different distributions between controller 302 and host 304 or are completely implemented using controller 302.

In an embodiment of an IoT ecosystem, the LAN protocol and the PAN protocol are co-located and share at least some resources (e.g., a host 304, controller 302, and physical layer 306). However, controller 302 implements at least separate link layers, e.g., PAN link layer 314 and LAN link layer 312. Each communications protocol also executes a separate carrier sensing layer as a separate software layer or as part of a corresponding link layer. In at least one embodiment, LAN carrier sensing layer 308 and PAN carrier sensing layer 310 execute independently on controller 302 to check the corresponding physical channel for availability for communications and initiating transmission of data (e.g., by forwarding a packet of data to the RF transceiver for transmission over the corresponding physical channel if the corresponding physical channel is available for communications). For example, LAN carrier sensing layer 308 receives an indication that LAN link layer 312 intends to transmit a packet using a corresponding physical channel. LAN carrier sensing layer 308 determines whether the physical channel is available for a transmission, e.g., by performing carrier sensing or energy detection over a duration of a predetermined number (e.g., eight) of symbols. If detected energy or a Received Signal Strength Indicator (RSSI) for the physical channel is above a predetermined level (e.g., a sensed energy level is above a predetermined energy threshold value for predetermined number of receiver intervals), then the corresponding physical channel is considered unavailable. If the corresponding physical channel is unavailable for a transmission, then LAN carrier sensing layer 308 triggers a backoff event before redetermining availability of the physical channel. In other embodiments, other coexistence techniques are used.

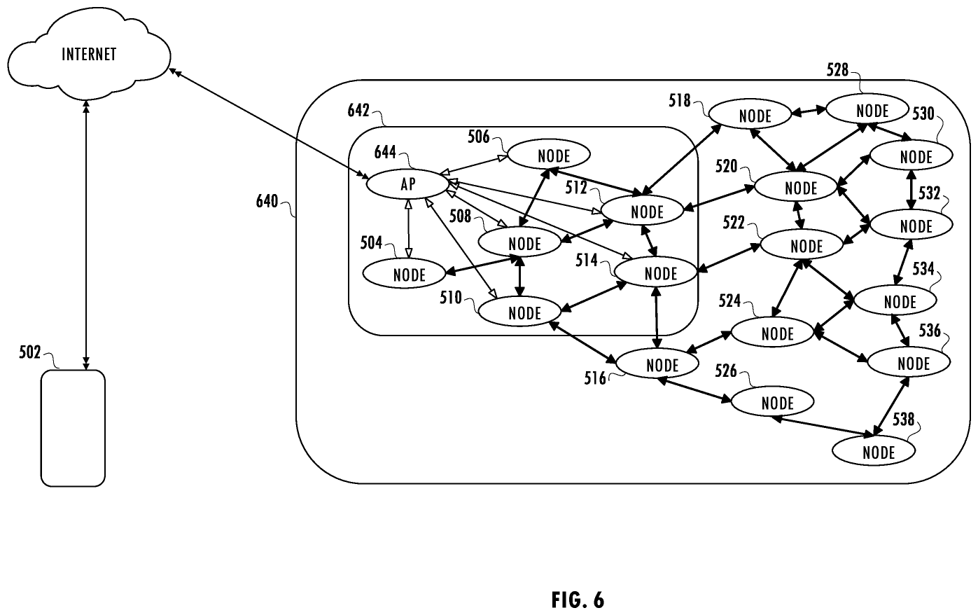

Referring to FIG. 5, in an initial network topology (e.g., an installer mode), IoT ecosystem 540 has no available LAN networking device. In at least one embodiment, wireless communications device 502 connects to multi-protocol node 504 using a Generic Attribute Protocol (GATT) over a BLE link. In other embodiments, other protocols and other types of links may be used. Multi-protocol nodes 504, 506, 508, . . . 538 communicate with each other using a BLE protocol and establish a BLE mesh network. Referring to FIG. 6, wireless communications device 502 uses conventional techniques to connect directly or indirectly to Wi-Fi access point 644. In an embodiment, wireless communications device 502 triggers LAN configuration of the IoT ecosystem. For example, wireless communications device 502 is a smart phone device connected to a BLE mesh upper layer application and shares a credential (e.g., Service Set IDentifier (SSID) and password) to all multi-protocol nodes. Multi-protocol nodes 504, 506, 508, and 510, are accessible to Wi-Fi access point 644 and announce that accessibility to neighboring multi-protocol nodes. Multi-protocol nodes 504, 506, 508 and 510 are provisioned as BLE mesh nodes and are configured for Wi-Fi connectivity in network 640. Note that Wi-Fi networked nodes 642 includes Wi-Fi access point 644 and multi-protocol nodes 504, 506, 508, . . . 514, which are directly and indirectly connected to Wi-Fi access point 644. The topology of FIG. 6 assumes that all of the nodes will support Wi-Fi and BLE mesh communications at all times, which cause redundant network communications that cause confusion. In embodiments in which the Wi-Fi protocol and the BLE mesh protocol share radio resources, the BLE mesh performance may degrade. In addition, with a substantial number of multi-protocol nodes accessible only via BLE mesh, the latency of communications increases for those multi-protocol nodes that require multiple hops.

An IoT ecosystem configuration technique that accesses a maximum number of multi-protocol nodes via a networking device and a minimum number of multi-protocol nodes sharing a radio across multiple communications protocols is described below. The multi-protocol nodes communicate connectivity information with each other, and each multi-protocol node self-determines its own connectivity configuration based on that information. For example, each multi-protocol node self-determines whether to be a pure Wi-Fi connectivity node, a pure BLE mesh connectivity node, or a Wi-Fi to BLE mesh bridge connectivity node. Multi-protocol nodes not acting as a bridge between Wi-Fi and BLE mesh communications and are reachable by Wi-Fi operate only as a Wi-Fi node and may disable BLE communications to reduce degradation of performance. Multi-protocol nodes out of reach of the Wi-Fi access point operate as BLE mesh only nodes and may disable Wi-Fi communications to reduce sharing of radio resources and hence degradation of performance.

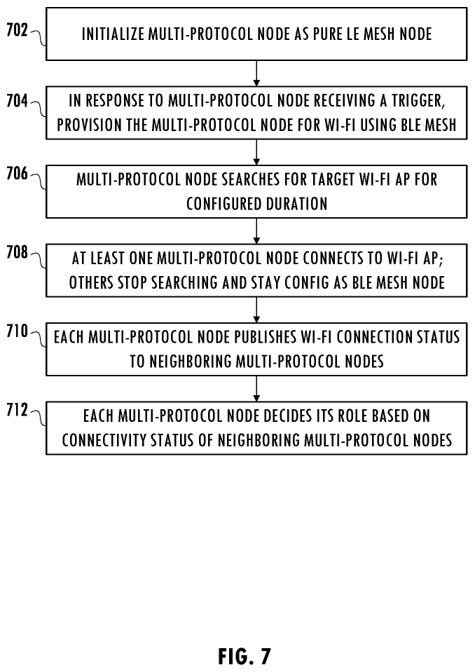

Referring to FIG. 7, in an exemplary embodiment of an IoT ecosystem including a plurality of multi-protocol nodes, each multi-protocol node initializes to a pure BLE mesh node configuration (702). After initialization and in response to a trigger (e.g., a trigger received from a smart device directly or indirectly using the BLE mesh protocol), each multi-protocol node provisions itself for Wi-Fi communications (704). Each multi-protocol node searches for a target Wi-Fi access point for a predetermined interval (706). Multi-protocol nodes timeshare radio resources to scan for a Wi-Fi access point and attempt to connect to the Wi-Fi access point. In an embodiment, at least one multi-protocol node connects to the Wi-Fi access point and at least one other multi-protocol node stops searching for the access point and stays configured as a BLE mesh node (708). Each multi-protocol node publishes its Wi-Fi connection status to neighboring multi-protocol nodes, e.g., using a field in a proprietary message encapsulated using BLE mesh protocol with a lifetime of a single hop (710). After the multi-protocol nodes have received the Wi-Fi connectivity status of neighboring multi-protocol nodes, each multi-protocol node self-determines its configuration based on the connectivity status of its neighboring multi-protocol nodes (712). For example, each multi-protocol node self-determines whether to configure as a pure Wi-Fi connectivity node (e.g., the multi-protocol node can access the Wi-Fi access point and finds all of its neighboring multi-protocol nodes to be connected to a Wi-Fi access point), a Wi-Fi to BLE mesh bridge connectivity node (e.g., the multi-protocol node can access the Wi-Fi access point and finds that at least one neighboring node is not within range of the Wi-Fi access point), or a pure BLE mesh connectivity node (e.g., the multi-protocol node is out-of-range or otherwise cannot connect to the Wi-Fi access point).

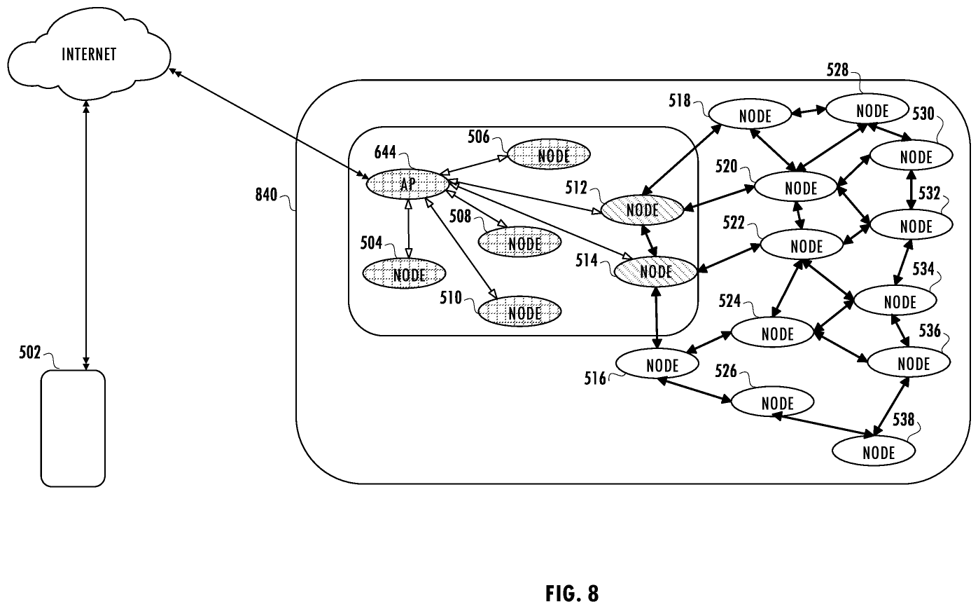

Referring to FIG. 8, multi-protocol nodes 504, 506, 508 and 510, which are in range of Wi-Fi access point 644, received indications that Wi-Fi access point 644 is accessible by their neighboring multi-protocol nodes. Therefore, multi-protocol nodes 504, 506, 508 and 510 need not be bridge connectivity nodes and configure themselves to be pure Wi-Fi nodes in heterogeneous network 840 and may disable their BLE mesh communications. Multi-protocol nodes 512 and 514, which are in range of Wi-Fi access point 644, receive indications that Wi-Fi access point 644 is not directly accessible by at least one neighboring multi-protocol node, and configure themselves as Wi-Fi-to-BLE mesh bridge connectivity nodes in heterogeneous network 840. Wi-Fi access point 644 is not directly accessible by multi-protocol nodes 516, 518, 520, . . . , and 538 and thus, multi-protocol nodes 516, 518, 520, . . . , and 538 configure themselves as pure BLE mesh nodes in heterogeneous network 840 and may disable their Wi-Fi communications.

The location of a Wi-Fi access point may change after the multi-protocol nodes configure themselves into a heterogeneous network topology. Multi-protocol nodes that were previously within range of the Wi-Fi access point may no longer be within the range of the Wi-Fi access point and are inadvertently dropped from the network. Multi-protocol nodes that were previously out-of-range of the Wi-Fi access point and were configured as pure BLE mesh nodes may become within range of the Wi-Fi access point. This scenario can be detected by wireless communications device 502 over the Internet by monitoring BLE keep alive packets generated by the multi-protocol nodes. If an application executing on wireless communications device 502 detects that a multi-protocol node is left out of the network, then the application issues a command that causes the multi-protocol nodes that are still in the network to reconfigure the network topology (e.g., an application executing on locally on each multi-protocol node triggers configuration or reconfiguration of the network topology). In response to the topology reconfiguration command, the multi-protocol nodes in the network enable the BLE mesh protocol to search for the multi-protocol node that was inadvertently left out of the network. In response to losing a connection to the Wi-Fi access point, a multi-protocol node enables the BLE mesh protocol to search for other nodes in its vicinity (e.g., within range of BLE communications). After finding all the multi-protocol nodes within the network, the application triggers the multi-protocol nodes to repeat steps 704-712 of the method of FIG. 7 to cause the multi-protocol nodes to reconfigure themselves in a heterogeneous network accordingly.

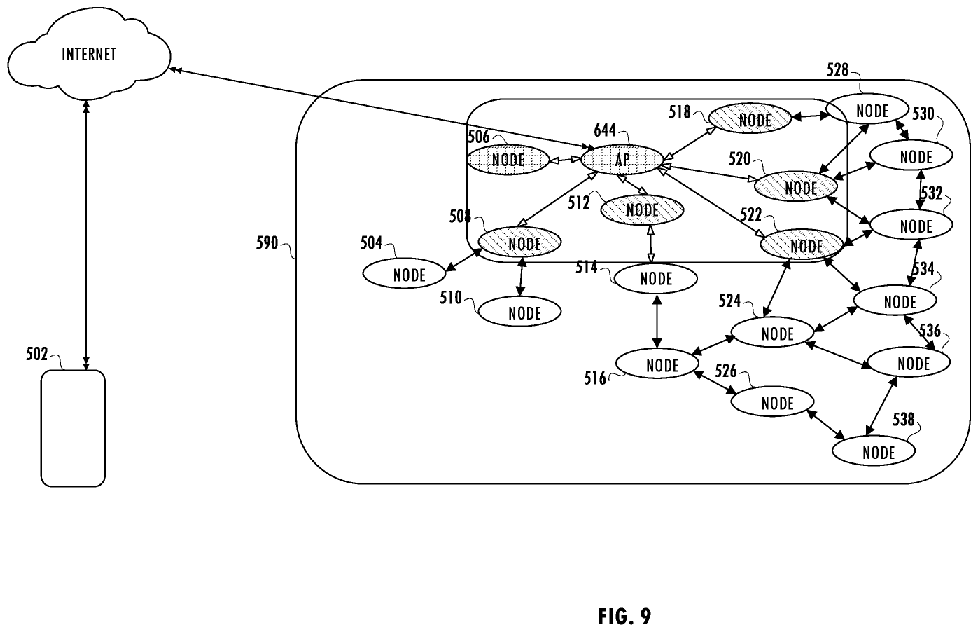

For example, relocation of Wi-Fi access point 644 causes the multi-protocol nodes to reconfigure themselves from the configuration of FIG. 8 (i.e., Wi-Fi access point 644 in direct connection with multi-protocol nodes 504, 506, 508, and 510, which are configured as pure Wi-Fi nodes, and with multi-protocol nodes 512 and 514, which are configured as Wi-Fi-to-BLE mesh bridge connectivity nodes) to the configuration of heterogeneous network 940 in FIG. 9 (i.e., Wi-Fi access point 644 is in direct connection with multi-protocol nodes 506, which is configured as a pure Wi-Fi node, and with multi-protocol nodes 508, 512, 518, 520, and 522, which are configured as Wi-Fi-to-BLE mesh bridge connectivity nodes). Multi-protocol nodes 504, 510, 514, 516, 524, 526, 528, . . . , and 538, are configured as pure BLE mesh nodes in FIG. 9. In at least one embodiment, the techniques described above result in a network of multi-protocol devices that are all pure Wi-Fi nodes, i.e., where all the multi-protocol devices are within range of the Wi-Fi access point, and no multi-protocol devices configure themselves as pure BLE mesh nodes or bridge connectivity nodes.

Thus, techniques for self-configuring multi-protocol nodes into a heterogeneous network without prior knowledge of the location of a Wi-Fi access point and to be accessible by a single Wi-Fi device even if a multi-protocol node does not have Wi-Fi connectivity, have been described. The techniques may reduce complexity in an IoT application. The techniques may be implemented using software (e.g., application layer 322 or application layer 323 of FIG. 4) executing on a processor (which includes firmware) or by a combination of software and hardware. Software, as described herein, may be encoded in at least one tangible (i.e., non-transitory) computer readable medium. As referred to herein, a tangible computer-readable medium includes at least a magnetic, optical, or electronic storage medium.

The description of the invention set forth herein is illustrative and is not intended to limit the scope of the invention as set forth in the following claims. For example, while the invention has been described in an embodiment in which multi-protocol nodes implement a Wi-Fi communications protocol and a BLE communications protocol, one of skill in the art will appreciate that the teachings herein can be utilized with multi-protocol nodes implementing other wireless communications protocols. In addition, while the invention has been described in an embodiment in which the IoT ecosystem is a lighting application, the techniques described herein are applicable to other IoT ecosystems or other applications. The terms “first,” “second,” “third,” and so forth, as used in the claims, unless otherwise clear by context, is to distinguish between different items in the claims and does not otherwise indicate or imply any order in time, location, or quality. For example, “a first received signal,” “a second received signal,” does not indicate or imply that the first received signal occurs in time before the second received signal. Variations and modifications of the embodiments disclosed herein may be made based on the description set forth herein, without departing from the scope of the invention as set forth in the following claims.

What is claimed is:

1. A method for operating a network of multi-protocol nodes comprising:
searching for a networking device associated with a first communications protocol by a first multi-protocol node of a plurality of multi-protocol nodes; and
the first multi-protocol node configuring itself to enable a first connectivity mode using the first communications protocol, enable a second connectivity mode using a second communications protocol, or enable a bridge connectivity mode using the first communications protocol and the second communications protocol based on whether the first multi-protocol node detects the networking device.

2. The method as recited in claim 1 further comprising:
prior to the searching, configuring the first multi-protocol node in the second connectivity mode.

3. The method as recited in claim 1 further comprising:
in response to a trigger event, using the second communications protocol to provision each of the plurality of multi-protocol nodes to enable the first communications protocol.

4. The method as recited in claim 1 wherein the first multi-protocol node enables the second connectivity mode in response to the first multi-protocol node failing to connect to the networking device.

5. The method as recited in claim 1 wherein the first multi-protocol node enables the first connectivity mode, enables the second connectivity mode, or enables the bridge connectivity mode further based on whether neighboring multi-protocol nodes of the plurality of multi-protocol nodes detect the networking device.

6. The method as recited in claim 5 further comprising:
the first multi-protocol node receiving indications of enabled connectivity modes of neighboring multi-protocol nodes.

7. The method as recited in claim 5 wherein the first multi-protocol node enables the first connectivity mode in response to all multi-protocol nodes neighboring the first multi-protocol node being connected to the networking device.

8. The method as recited in claim 4 wherein the first multi-protocol node enables the bridge connectivity mode in response to at least one multi-protocol node neighboring the first multi-protocol node failing to connect to the networking device.

9. The method as recited in claim 1 further comprising:
all other multi-protocol nodes of the plurality of multi-protocol nodes enabling the first connectivity mode, enabling the second connectivity mode, or enabling the bridge connectivity mode based on whether each other multi-protocol node detects the networking device.

10. The method as recited in claim 9 wherein all the other multi-protocol nodes configure themselves to enable the first connectivity mode, enable the second connectivity mode, or enable the bridge connectivity mode further based on whether corresponding neighboring multi-protocol nodes detect the networking device.

11. The method as recited in claim 1 wherein the first communications protocol is a wireless local area network protocol and the second communications protocol is a wireless personal area network mesh network protocol.

12. A network of multi-protocol nodes, the network comprising:
a multi-protocol node comprising:
a radio frequency transceiver configured to transmit and receive radio frequency signals; and
data processing circuitry operable to:
use the radio frequency transceiver to search for a networking device associated with a first communications protocol; and
enable a first connectivity mode using the first communications protocol, enable a second connectivity mode using a second communications protocol, or enable a bridge connectivity mode using the first communications protocol and the second communications protocol based on whether the multi-protocol node detects the networking device.

13. The network as recited in claim 12 wherein the data processing circuitry comprises:
a storage element; and
a processor configured to execute instructions stored in the storage element, the instructions being executable by the processor to cause the processor to:
configure the radio frequency transceiver and the data processing circuitry to search for a networking device associated with the first connectivity mode and selectively enable the first connectivity mode, the second connectivity mode, or the bridge connectivity mode based on whether the multi-protocol node detects the networking device.

14. The network as recited in claim 13 wherein the instructions are further executable by the processor to:
configure the multi-protocol node in the second connectivity mode prior to the search; and
in response to a trigger event, use the second communications protocol to provision each multi-protocol node of a plurality of multi-protocol nodes to enable the first communications protocol.

15. The network as recited in claim 13 wherein the instructions are further executable by the processor to enable the second connectivity mode in response to the multi-protocol node failing to connect to the networking device.

16. The network as recited in claim 13 wherein the instructions are further executable by the processor to enable the first connectivity mode, enable the second connectivity mode, or enable the bridge connectivity mode further based on whether neighboring devices of a plurality of multi-protocol nodes detect the networking device.

17. The network as recited in claim 13 wherein the multi-protocol node enables the first connectivity mode in response to all multi-protocol nodes neighboring the multi-protocol node being connected to the networking device.

18. The network as recited in claim 13 wherein the multi-protocol node enables the bridge connectivity mode in response to at least one multi-protocol node neighboring the multi-protocol node failing to connect to the networking device.

19. The network as recited in claim 13 the instructions are further executable by the processor to:
self-enable, by all other multi-protocol nodes of a plurality of multi-protocol nodes, the first connectivity mode, the second connectivity mode, or the bridge connectivity mode based on whether each other multi-protocol node detects the networking device,
wherein all the other multi-protocol nodes configure themselves to enable the first connectivity mode, the second connectivity mode, or the bridge connectivity mode further based on whether corresponding neighboring multi-protocol nodes detect the networking device.

20. A multi-protocol node comprising:
a storage element; and
a processor configured to execute instructions stored in the storage element, the instructions being executable to selectively update a corresponding connectivity mode from an initial connectivity mode based whether the multi-protocol node detects a networking device and based on another corresponding connectivity mode of a neighboring multi-protocol node.
